(19) United States
(12) Patent Application Publication
(10) Pub. No.: US 2007/0265029 A1
(43) Pub. Date: Nov. 15, 2007

(54) Speaker module of portable communication device

(75) Inventor: Chi-Yi Tsai, Taichung City (TW)

Correspondence Address: BIRCH STEWART KOLASCH & BIRCH, PO BOX 747, FALLS CHURCH, VA, 22040-0747, US

(73) Assignee: MERRY ELECTRONICS CO., LTD.

(21) Appl. No.: 11/402,060

(22) Filed: Apr. 12, 2006

(51) Int. Cl. H04M 1/00

(52) U.S. Cl. 455/550.1

(57) ABSTRACT

A speaker module of a portable communication device includes a shell and a speaker module. The speaker module includes a speaker, a base and a wall. The wall connects with the base. The shell has two half shells. The shell and the wall define an acoustic cavity when the two half shells are connected. Consequently, the acoustic cavity is defined alongside the speaker, which reduces entire height of the speaker module. The entire height of the communication device can be also reduced to meet the demands of thin, light and compact features for the communication device.

### BACKGROUND

1. Field of Invention

The present invention relates to a speaker module of a portable communication device, and more particularly to a speaker module of a portable communication device having an acoustic cavity positioned alongside the speaker.

2. Description of Related Art

The trend of miniaturizing portable communication devices, such as mobile phones or PDA (personal digital assistant), is unstoppable. Thus, the speaker in the portable communication device must be minified.

Speakers have different structures and sizes for different purposes. An acoustic cavity is used to improve the whole volume of the speakers. Within a reasonable range, the bigger the volume of the acoustic cavity is, the greater the whole sound volume of the speaker is.

In a conventional speaker structure, the acoustic cavity is placed above the diaphragm. Thus, the entire height of the speaker must include the height of the acoustic cavity. For miniaturization of the portable communication device, the volume of the acoustic cavity of the conventional speaker is reduced relatively. However, the entire height of the speaker can't be reduced, and the sound performance of the conventional speaker is thus restricted.

The above-mentioned conventional speaker of the portable communication device needs bigger mounting space and assembling structures. The cost and manufacturing processes of fabricating the portable communication device are generally high. Since the portable communication device and the speaker module need to be mass-produced, the cost accumulated is considerable.

### SUMMARY

An objective of the present invention is to provide a speaker module of a portable communication device, which can reduce the entire height of the portable communication device.

Another objective of the present invention is to provide a speaker module, which can increase the sound performance. Hence, the positioning structures for the speaker module in the portable communication device are simple to assemble.

### BRIEF DESCRIPTION OF THE DRAWINGS

The accompanying drawings are included to provide a further understanding of the invention and are incorporated in and constitute a part of this specification. The drawings illustrate embodiments of the invention and, together with the description, serve to explain the principles of the invention. In the drawings,

FIG. 1 is an exploded perspective view (from top) of a speaker module of a portable communication device of the preferred embodiment in accordance with the present invention;

FIG. 2 is an exploded perspective view (from bottom) of a speaker module of a portable communication device of the preferred embodiment in accordance with the present invention;

FIG. 3(a) is a bottom view of a speaker module of a portable communication device of the preferred embodiment in accordance with the present invention;

FIG. 3(b) is a side view of a speaker module of a portable communication device of the preferred embodiment in accordance with the present invention;

FIG. 3(c) is a top view of a speaker module of a portable communication device of the preferred embodiment in accordance with the present invention;

FIG. 4(a) is an exploded perspective view (from top) of a speaker module of a portable communication device of the preferred embodiment in accordance with the present invention;

FIG. 4(b) is a perspective view (from top) of a speaker module of a portable communication device of the preferred embodiment in accordance with the present invention;

FIG. 5(a) is an exploded perspective view (from bottom) of a speaker module of a portable communication device of the preferred embodiment in accordance with the present invention;

FIG. 5(b) is a perspective view (from bottom) of a speaker module of a portable communication device of the preferred embodiment in accordance with the present invention; and

FIG. 6 is a plot of frequency-response curves of a speaker module of a portable communication device of the preferred embodiment in accordance with the present invention and a conventional speaker.

### DESCRIPTION OF THE PREFERRED EMBODIMENTS

Reference is now made in detail to the present preferred embodiments of the invention, examples of which are illustrated in the accompanying drawings. Wherever possible, the same reference numbers are used in the drawings and the description to refer to the same or like parts.

While the specification concludes with claims defining the features of the invention that are regarded as original, it is believed that the invention is better understood from a consideration of the following description in conjunction with the figures, in which like reference numerals are carried forward.

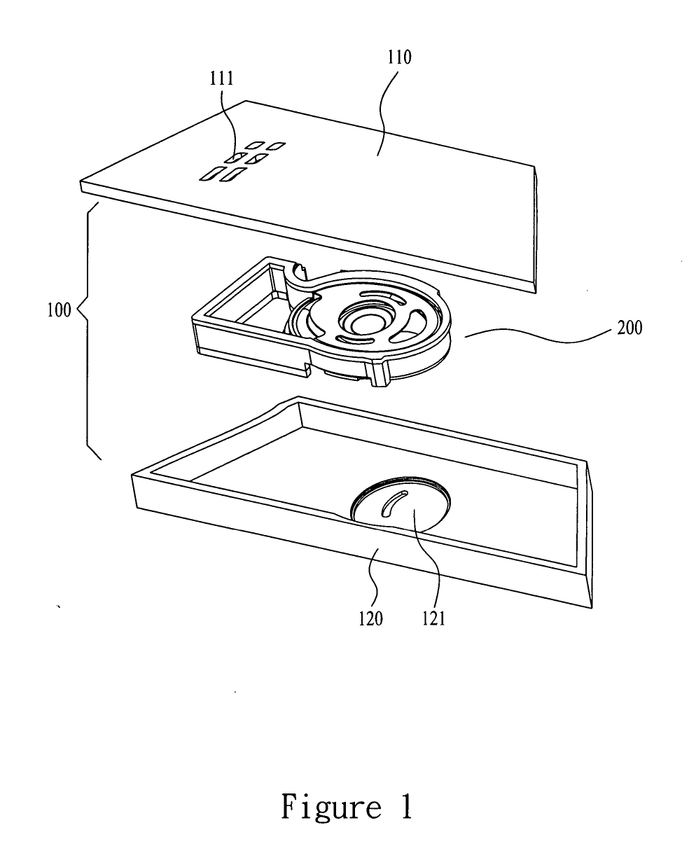

Reference is made to FIG. 1, which is an exploded perspective view of a speaker module of a portable communication device in accordance with the preferred embodiment of the present invention. A portable communication device includes a shell 100, which includes a first half-shell 110 and a second half-shell 120.

The first half-shell 110 includes at least one acoustic hole 111. The second half-shell 120 includes a second recess 121.

The acoustic hole 111 allows the sound produced by a speaker module 200 transmitting out of the shell 100. While assembling the speaker module 200 inside the shell 100, the second recess 121 simply positions the speaker module 200 for steady state.

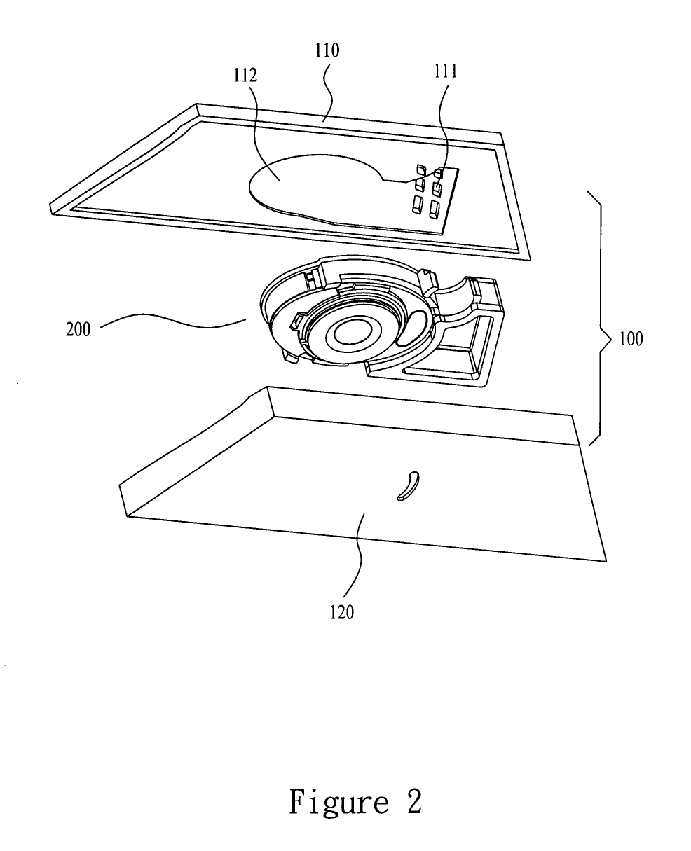

Reference is made to FIG. 2, which is an exploded perspective view of a speaker module of a portable communication device of the preferred embodiment of the present invention. The first half-shell 110 includes a first recess 112.

While assembling the speaker module 200 into the shell 100, the recesses 111, 112 simply hold the speaker module 200 in position for quickly and convenient assembling process.

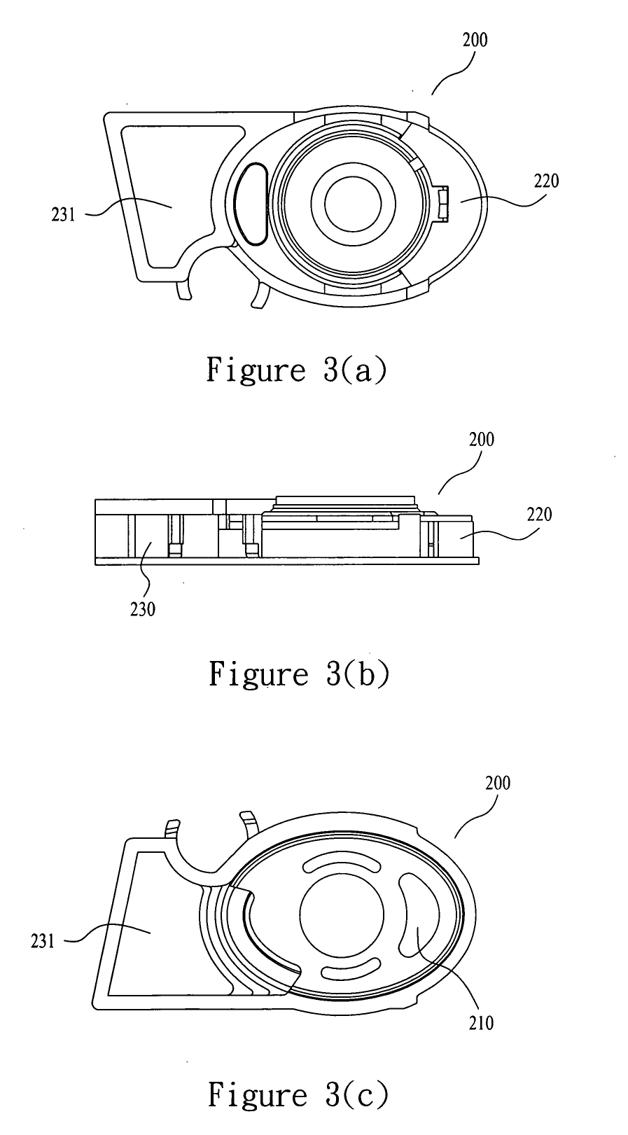

Reference is made to FIGS. 3(a), 3(b) and 3(c), which illustrate a bottom view, a side view and a top view of a speaker module of the preferred embodiment in accordance with the present invention respectively. The speaker module 200 includes a speaker 210, a base 220 and a wall 230.

The speaker 210 is mounted on the base 220. The wall 230 is connected to the base 220 integrally. For example, the base 220 and the wall 230 can be made simultaneously by plastic injection molding process.

Reference is made to FIG. 1 and FIG. 2 together; the wall 230, the first half-shell 110 and the second half-shell 120 define a hollow acoustic cavity 231 when the two half-shell 110, 120 are connected to each other. The acoustic cavity 231 communicates with the acoustic hole 111, which allows sound resonated in the acoustic cavity 231 being transmitted out of the shell 100 20 through the hole 111.

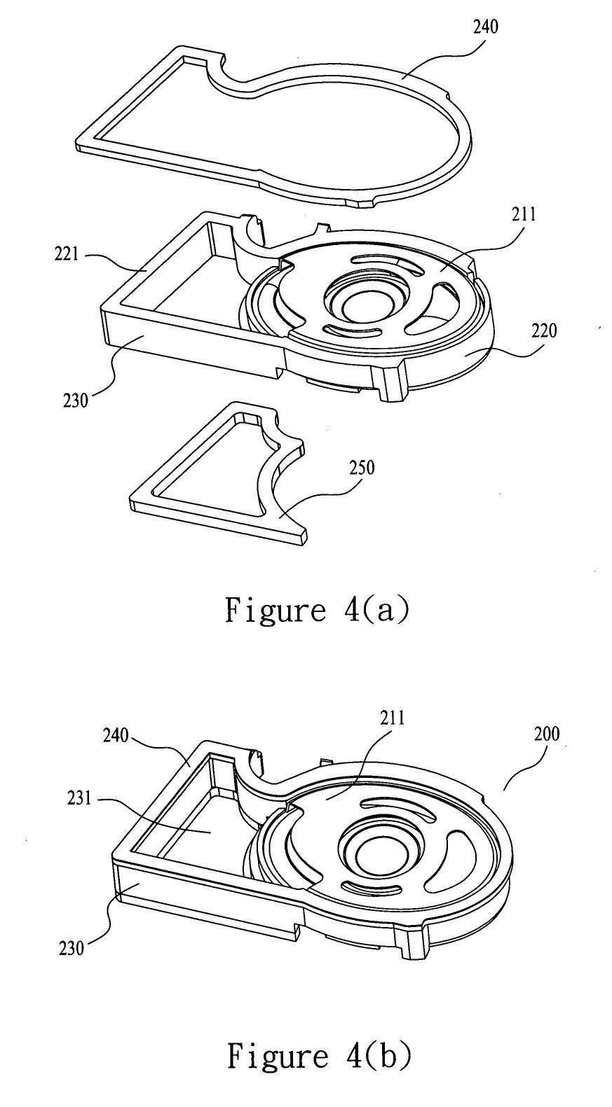

Reference is made to FIG. 4(a), which is an exploded perspective view of a speaker module of the preferred embodiment in accordance with the present invention. The speaker module 200 includes a first sealing member 240 and a second sealing member 250.

The first sealing member 240 can be attached on a first surrounding edge 211 of the wall 230 and the base 220 and is positioned between and squeezed by the first half-shell 110 and the wall 230 and the base 220. Likewise, the second sealing member 250 can be attached on a second surrounding edge 222 of the wall 230 and is positioned between and squeezed by the second half-shell 120 and the wall 230 (reference is made to FIG. 1).

The first sealing member 240 and the second sealing member 250 are good sound absorption materials or sound insulation materials, such as sponge or the like. Therefore, using the sealing members 240, 250 will prevent the sound inside the acoustic cavity from leaking, which increases sound performance.

Reference is made to FIG. 4(b), which is an exploded perspective view of a speaker module of the preferred embodiment in accordance with the present invention. The speaker 210 includes a sound producing surface 211. The position of the sound producing surface 211 is different from the acoustic hole 111 (reference is made to FIG. 1). The sound produced from the sound producing surface 211 passes through the acoustic cavity 231 and is transmitted out of the shell 100 via the acoustic hole 111. Thus, the speaker module 200 has a feature that the sound is transmitted toward the side of the speaker 210.

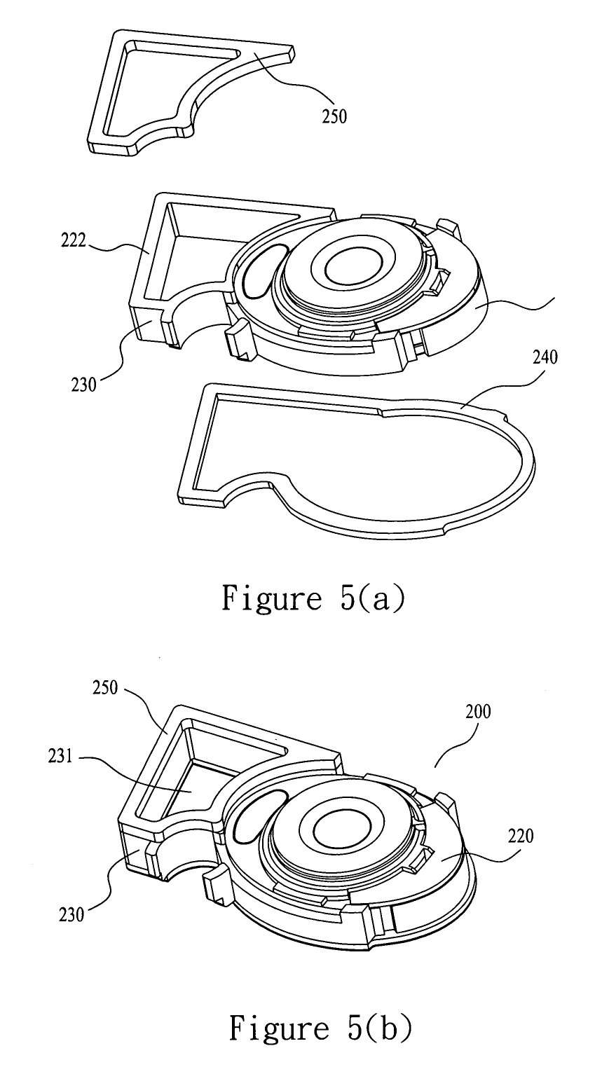

Reference is made to FIG. 5(a), which is an exploded perspective view of a speaker module of the preferred embodiment in accordance with the present invention. The second sealing member 250 can be attached on the second surrounding edge 222, and then is positioned between the second half-shell 120 and the wall 230 (reference is made to FIG. 2). FIG. 5(b) is a perspective view of a speaker module of the preferred embodiment in accordance with the present invention (an oblique bottom view of the speaker module), illustrating the bottom structure of the base 220 and the second sealing member 250 attached on the wall 230.

The speaker 210, the base 220 and the wall 230 can be assembled in proper order or connected integrally to produce the speaker module 200.

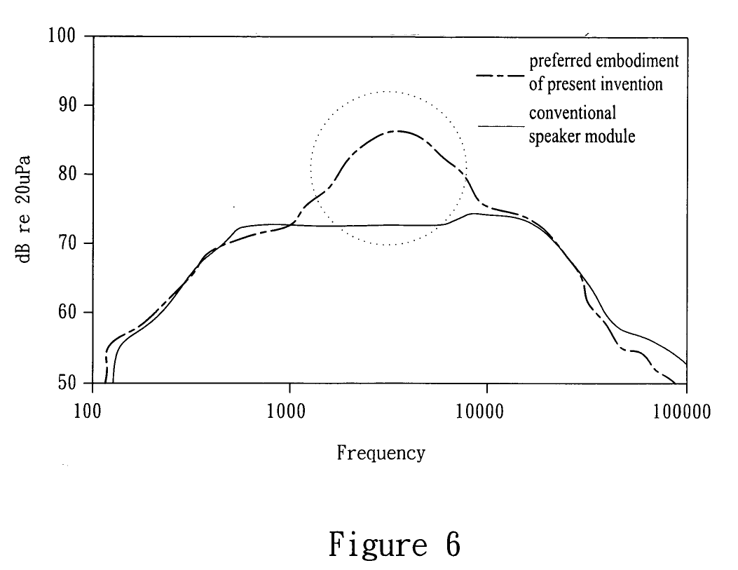

Reference is made to FIG. 6, illustrating that the frequency-response curve of the preferred embodiment in accordance with the present invention is obviously higher than the conventional speaker module in the range from 1,000 Hz to 10,000 Hz (shown as a dotted circle). Thus, the sound volume of the preferred embodiment in accordance with the present invention is larger than the conventional speaker module, too.

According to the composition and the embodiments above, there are many advantages of the present invention over the prior art, such as:

1. The acoustic cavity is defined at the side of the speaker for improving sound effects of the speaker module, which renders the speaker module thin and compact. While assembling the speaker module into a portable communication device, it can be matched with a slimmer shell to reduce the entire height of the portable communication device.

2. Manufacturing the speaker, base and wall is simplified because the base and the wall are plastic molded parts. The manufacturing process can be done by means of injection molding, which can lower cost and enhance durability of the speaker module effectively.

3. When the speaker module is assembled into a shell of a portable communication device, the recesses in the shell help position the speaker module in the shell. The yield of production can be raised and the amount of bad products can be decreased.

4. Because of the side acoustic cavity for the speaker, the volume of the acoustic cavity can be bigger than the conventional one. The bigger volume of the acoustic cavity can improve the sound performance effectively.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A portable communication device comprising:
a shell comprising a first half-shell and a second half-shell, and the first half-shell having at least one acoustic hole; and
a speaker module assembled in the shell and comprising:
a base;
a wall connected to the base; and
a speaker mounted to the base;
wherein the wall, the first half-shell and the second half-shell define an acoustic cavity when the first half-shell connects to the second half-shell to form the shell, and the acoustic cavity communicates with the at least one acoustic hole.

2. The portable communication device of claim 1, wherein the first half-shell has a first recess corresponding to the speaker module.

3. The portable communication device of claim 1, wherein the second half-shell has a second recess corresponding to the speaker module.

4. The portable communication device of claim 1, wherein the wall and the base have a first surrounding edge;
the wall has a second surrounding edge opposite to the first surrounding edge of the wall; and
the speaker module further includes:
a first sealing member mounted between the first half-shell and the first surrounding edge; and
a second sealing member mounted between the second half-shell and the second surrounding edge.

5. The portable communication device of claim 4, wherein the sealing members are sponge.

6. The portable communication device of claim 1, wherein the speaker has a side and an sound producing surface located in different positions relative to the at least one acoustic hole, whereby sound produced by the speaker is transmitted to the acoustic cavity from the side of the speaker.

7. A speaker module, comprising:
a base;
a speaker mounted on the base and having a side and a sound producing surface; and
a wall connected to the base and defining an acoustic cavity with the base, and the acoustic cavity being at the side of the speaker for receiving sound produced from the sound producing surface.

8. The speaker module of claim 7, further comprising:
the wall and the base have a first surrounding edge;
the wall has a second surrounding edge opposite to the first surrounding edge of the wall; and
the speaker module further includes:
a first sealing member mounted between the first half-shell and the first surrounding edge; and
a second sealing member mounted between the second half-shell and the second surrounding edge.

9. The speaker module of claim 8, wherein the sealing members are sponge.

10. The speaker module of claim 7, wherein the base and the wall are connected integrally by an injection molding process and the speaker is mounted on the base during the injection molding process.
